(19) United States
(12) Patent Application Publication
(10) Pub. No.: US 2015/0037468 A1
(43) Pub. Date: Feb. 5, 2015

(54) BAKERY PRODUCT AND METHOD OF PRODUCING A BAKERY PRODUCT

(71) Applicant: Griesson - de Beukelaer GmbH & Co. KG, Polch (DE)

(72) Inventors: Anja SCHNELL, Sankt Sebastian (DE); Lena OTTEN, Koblenz (DE); Juergen FABIAN, Dieblich (DE)

(21) Appl. No.: 14/448,175

(22) Filed: Jul. 31, 2014

(30) Foreign Application Priority Data
Aug. 1, 2013 (EP) 13178874.7

(51) Int. Cl. A21D 13/00

(52) U.S. Cl. CPC A21D 13/0009
USPC 426/94; 426/307

(57) ABSTRACT

A bakery product and method of producing the same are provided. The bakery item includes a baked item having an underside, an upper side, and side surface. A first underside sub-region that extends over the entire width and part of the longitudinal extent of the underside is coated. A second underside sub-region that extends over the entire width and part of the longitudinal extent remains uncoated in the form of a grip region. The sub-region of the partial-coat underside which is to be coated is dipped into a bath of not yet set coating substance, which is set by cooling to form the coating. The underside of the baked item, which is to be coated, is oriented at an angle α between 1° and 20° in relation to the original surface of the bath at least during the setting operation.

The invention relates to a method of producing a bakery product which comprises a baked item having an underside, which is formed by at least one, preferably at least essentially planar, surface, having an upper side, which is formed by at least one, preferably at least essentially planar, surface, and having at least one side surface, which connects the upper side and the underside to one another, wherein a sub-region of the underside of the baked item is provided with a coating.

The baked item here has a longitudinal extent in an imaginary longitudinal direction, wherein this is understood as meaning, in particular, that extent of the baked item which is oriented orthogonally in relation to the general progression of the general transition which is formed, following the coating operation, between the uncoated, second sub-region and the coated, first sub-region. Otherwise, that extent of the baked item which is intended here is that which runs between the coated end and the end remaining uncoated and which is oriented possibly parallel to at least one baked-item edge which runs more or less in the form of a side edge.

One end region of said longitudinal extent here is provided with the coating. The baked item also has a width which runs orthogonally in relation to the longitudinal extent.

Methods of coating baked items by dipping are known. The baked item which is to be coated is dipped, for example, into a bath of liquid chocolate by way of an essentially vertical movement and then pulled out. This only allows coating of the baked item on all sides, with the exception of the grip region. A cooling step follows. The disadvantage is that, once the baked item has been pulled out of the bath, the coating can drip up until the point in time at which it has set at least on the surface. If the bakery product is to have a surface relief, this has to be introduced into the baked item. The operation of dipping the baked item into the coating substance means that contours of the surface relief introduced into the baked item may become indistinct.

It is an object of the invention to avoid the aforementioned disadvantages and to specify a method which makes it possible to coat just an underside sub-region which extends over the entire width of the underside.

This object is achieved in that a first sub-region of the underside, which extends over the entire width, but only over part of the longitudinal extent, is coated and a second sub-region of the underside, which extends in particular over the entire width, but only over part of the longitudinal extent, remains uncoated in the form of a grip region, wherein, for coating purposes, use is made of a mould, in which a bath of not yet set coating substance is provided, wherein the baked item has that first sub-region of the partial-coat underside which is to be coated dipped into the not yet set coating substance and then the coating substance is set, in particular by cooling, and thus forms the coating, wherein the underside of the baked item, which is to be coated, is oriented at an angle α between 1° and 20° in relation to the original surface of the bath of the not yet set coating substance at least during the operation of setting the not yet set coating substance. If the baked item is of rectangular design, the baked item has a total of four side surfaces. If it is of round configuration, just one side surface is provided.

The oblique positioning means that the formation of thin coating regions which are beyond a limit which is actually desired, and are also referred to as “burrs”, is reduced or even avoided.

If the surface of the underside is formed by at least two surfaces, it is possible, for the purpose of looking at orientation and angles, to use the theoretical line or plane through the bearing point or the bearing line of the underside on the bearing region, on the one hand, and through the lowermost point or the lowermost line or the middle of the lowermost region in the longitudinal direction of the underside, on the other hand, instead of “underside”.

The “original surface of the bath” is understood as meaning the surface of the bath prior to the baked item being dipped in. If the coating substance used is a liquid, the original surface of the bath runs horizontally. The liquid may be, for example, liquid chocolate.

Dipping or dipping in is understood as meaning the process during which the baked item, upon coming into contact with the surface of the bath, sinks readily into the coating substance on account of its weight. It is also possible for a specific pushing-in action to take place. This means that the level of the coating substance rises as a result of the coating substance being displaced by part of the baked item sinking into the same, and therefore the sub-region which is to be coated is coated.

The method according to the invention allows the underside to be coated only in the first sub-region, which extends over the entire width of the baked item. The baked item also has a grip region, which is uncoated both on the underside and on the upper side, and this therefore makes it possible for the bakery product to be gripped by two fingers without the fingers coming into contact with the coating.

This grip region can extend over the entire width of the baked item, but may also be provided just in a sub-region, laterally or at a distance apart from the two lateral side surfaces.

If the grip region does not extend over the entire width, it is possible for at least one further region which likewise has a coating to be provided laterally alongside the grip region.

In the case of a coating which is located only on the first sub-region of one of the two surfaces, for example of the underside, the bakery product can be set down on any underlying surface, for example even on a table top, by way of its uncoated surface, and therefore the coating does not remain adhering to the underlying surface.

The transition between the uncoated sub-region and the coated sub-region may be designed, and positioned, as desired. If a rectangular baked item is intended to have a likewise rectangular grip region, the transition runs parallel to at least one side surface of the baked item. If the intention is for just one corner of the quadrilateral baked item to form a grip region, the transition can run at an angle other than 90° to the four side surfaces of the baked item. As an alternative, however, transitions which are curved or shaped in any desired manner are also possible.

The underside of the baked item need not necessarily be the underside of the subsequently produced bakery product. Rather, it is also possible for the surface which is referred to as the underside during production to be the subsequent upper side of the finished bakery product. All of the coating substance located in the mould constitutes the subsequently set coating of the bakery product.

The underside comprises preferably just the first sub-region and the second sub-region, which is designed in the form of a grip region. The baked item may be, for example, a plain butter biscuit. Of course, other suitable baked items are also possible, e.g. items baked from yeast-based doughs and short crust pastry, hard biscuits, waffles, gingerbread, crackers, items baked from soda dough, wafers, rusks, meringues, sponge cakes, breads, flatbread and crispbread.

A recommended coating is, for example, milk chocolate or dark chocolate. Of course, other suitable coatings are also conceivable, e.g. chocolate, butter icing, fondant/sugar paste, caramel, brittle, jelly, fruit gum/wine gum, cheese and aspic.

The angle α may be between 1° and 20°. It is advantageously possible for the angle α to be between 1° and 5°, preferably to be 2°.

The baked item may be of quadrilateral, in particular rectangular, design. If the baked item is of rectangular configuration, the coated, first sub-region may likewise be of rectangular design and can extend up to a total of three side surfaces which bound the underside. As an alternative, any other desired geometrical or figurative shapes of the baked item and of the coating are also possible.

The baked item may have, for example, a length of approximately 6 cm, a width of approximately 5 cm and a height of approximately 0.5 cm, wherein the coating may be approximately 0.3 cm. It is recommended if the grip region has a depth and/or width of approximately 1 to 2 cm, so that the bakery product can be gripped to good effect by two fingers without the fingers coming into contact with the coating.

Any desired shapes of the baked item are possible. If the baked item is of round configuration, the coated, first sub-region may be designed in the manner of a semicircle or in the form of a sickle and can extend up to the opposite regions of the side surface. Alternative configurations are possible in any desired shape.

The thickness of the coating can increase from the free end of the first sub-region to the grip region at least along a sub-region of the longitudinal extent of the first sub-region. The thickness of the coating can decrease from the free end of the first sub-region to the grip region at least along a sub-region of the longitudinal extent of the first sub-region.

As an alternative, the thickness of the coating may be constant at least along a sub-region of the longitudinal extent of the first sub-region.

The height of the coating substance in the mould may be such that the baked item, by virtue of being dipped into the not yet set coating substance, is provided with a coating even in at least one of those regions of at least one of the side surfaces which are adjacent to the first sub-region, which is to be coated. If the baked item is of rectangular configuration and in the case of a transition between the uncoated, second sub-region and the coated, first sub-region being oriented parallel to two side surfaces of the baked item, the coating thus extends over a total of three opposite side surfaces. It is the case here that the middle one of the three side surfaces would be coated over its entire length and the other two, mutually opposite side surfaces would be coated only over part of their respective length. As seen in plan view of the bakery product, the coating would partially enclose the baked item in the manner of a “U”. On the two opposite side surfaces, the height of the coating decreases as the distance from the middle side surface increases. The term “height” is used for the coating located laterally alongside the baked item, whereas the term “thickness” is used for the coating located beneath the baked item.

The baked item can be dipped into the not yet set coating substance to such an extent that, with the baked item dipped in, the coating substance, in that region of the baked item which dips into the lowest level, terminates approximately flush with the respectively corresponding edge between at least one side surface and the upper side of the baked item. If the baked item is of rectangular design and the transition between the uncoated, second sub-region and the coated, first sub-region is oriented parallel to two side surfaces of the baked item, one side surface is coated in its entirely, whereas the height of the coating on the two adjacent, mutually opposite side surfaces decreases as the distance from the fully coated side surface increases.

The upper side of the baked item here remains fully uncoated.

The baked item can be dipped into the not yet set coating substance to such an extent that the coating also partially covers over the upper side of the baked item. As far as a rectangular baked item is concerned, on the one hand, this would mean that a sub-region of the underside and a sub-region of the upper side are coated. On the other hand—if the transition between the uncoated, second sub-region and the coated, first sub-region is oriented parallel to two side surfaces of the baked item—one side surface would be coated in its entirety, whereas the height of the coating on the two adjacent, mutually opposite side surfaces could decrease in a certain sub-region as the distance from the fully coated side surface increases.

The mould may have a dipping-in region which accommodates the not yet set coating substance and has a base and a bearing region, wherein the baked item rests on the bearing region and, by virtue of the bearing region, the second sub-region of the baked item, which is not to be coated, is shielded, in particular with sealing action, from the coating substance. The bearing region constitutes, to this extent, a barrier, in front of which the coating substance accumulates. The baked item is thus oriented on the bearing region such that it sinks into the coating substance by way of its first sub-region, which is to be coated.

The mould may have, preferably in the bearing region, at least two spaced-apart fixing elements, which fix the baked item laterally during the dipping-in operation. It is also possible to provide just one fixing element, preferably in the bearing region.

That edge of the bearing region which is directed toward the coating substance is of sharp-edged design, or designed in the form of a thin edge, preferably in order to achieve good sealing. It is also possible, however, for it to be of slightly rounded design, wherein the radius of the rounding is preferably between 0.1 and 0.5 mm.

The bearing region may be designed in the form of an at least approximately vertically upwardly extending crosspiece which runs over the entire width of the mould. This crosspiece may be, for example, a sheet-metal or plastics-material strip.

The bearing region may be designed in the form of a planar bearing surface which extends in particular beyond the free end of the baked item.

The surface of the bearing region may be oriented at an angle α″, which is between 1° and 20°, preferably 2°, to the surface of the coating substance prior to the baked item being dipped in.

The base of the dipping-in region may be oriented at an angle α′, which is between 0° and 20°, preferably 2°, to the original surface of the coating substance. It is possible here for the base to be designed to slope up preferably in the direction of the bearing region.

The base of the dipping-in region may have a positive or negative relief or the like. It is thus possible to realize any desired configuration for the surface of the set coating. It is also possible in this way for example for names or logos to be introduced into the coating and to be represented in the set coating of the finished bakery product.

It is possible here, in the region located laterally in relation to the second sub-region of the baked item, which is not to be coated, for the mould to have side walls with a vertical orientation corresponding to the shape of the baked item, wherein, in the dipped-in position of the baked item, the second sub-region of the side surface(s) of the baked item, which is not to be coated, is shielded, in particular with sealing action, from the coating substance by the side walls. A side wall is provided on each side of the baked item. This also serves the purpose of orienting and/or fixing the baked item.

The bearing region, preferably on the side directed towards the coating substance, is oriented at an angle β, which is between 50° and 90°, preferably is 62°, to the original surface of the bath. The bearing region, on its side which is directed away from the coating substance, is oriented at angle γ of approximately 90° to the original surface “D” of the bath. As an alternative, the angle may be in the range 0−γ< (180°−β).

Once the baked item has been placed in position, the mould, which has been filled to this extent, may be subjected to vibration. Part of the baked item here sinks into the coating substance.

Following completion of the operation of the baked item sinking in, the mould can be cooled. This results in the coating substance setting, and a coating forms. The bakery product can now be removed from the mould. For this purpose, it is possible for the mould to be, for example, turned and—if the mould is sufficiently flexible—twisted, in order to facilitate removal.

The invention also relates to a bakery product comprising a baked item having at least one underside, which is formed by at least one, preferably at least essentially planar, surface, having an upper side, which is formed by at least one, preferably at least essentially planar, surface, and having at least one side surface, which connects the upper side and the underside to one another, in particular produced by one of the methods described above.

The baked item here has a longitudinal extent, wherein this is understood as meaning, in particular, that extent of the baked item which is oriented orthogonally in relation to the general progression of the general transition which is formed, following the coating operation, between the uncoated, second sub-region and the coated, first sub-region. Otherwise, that extent of the baked item which is intended here is that which runs between the coated end and the end remaining uncoated and which is oriented possibly parallel to at least one baked-item edge which runs more or less in the form of a side edge.

One end region of said longitudinal extent here is provided with the coating. The baked item also has a width which runs orthogonally in relation to the longitudinal extent.

Bakery products which are coated on all sides, with the exception of a grip region, by way of an essentially vertical dipping-in movement into a bath are known. The disadvantage here is that, once the baked item has been pulled out of the bath, the coating can drip up until the point in time at which it has set at least on the surface. If the bakery product is to have a surface relief, this has to be introduced into the baked item. The operation of dipping the baked item into the coating substance means that contours of the surface relief introduced into the baked item may become indistinct.

It is an object of the invention to avoid the aforementioned disadvantages and to specify a bakery product in the case of which the underside of the baked item is coated only in a first sub-region, which extends over the entire width.

This object is achieved in that a first sub-region of the underside of the baked item is provided with a coating which extends over the entire width, but only over part of the longitudinal extent, and a second sub-region of the underside, which extends in particular over the entire width, but only over part of the longitudinal extent, is uncoated in the form of a grip region, wherein the upper side of the baked item is likewise uncoated at least in the grip region.

The underside of the bakery product according to the invention is coated only in a first sub-region, which extends over the entire width of the baked item. The baked item also has a grip region, which is uncoated both on the underside and on the upper side, and this therefore makes it possible for the bakery product to be gripped by two fingers without the fingers coming into contact with the coating. In the case of a coating which is located only on the sub-region of one of the two surfaces, for example of the underside, the bakery product can be set down on any underlying surface, for example even on a table top, by way of its uncoated surface, and therefore the coating does not remain adhering to the underlying surface.

The transition between the uncoated, second sub-region and the coated, first sub-region may be designed, and positioned, as desired. If a rectangular baked item is intended to have a likewise rectangular grip region covering over the entire width, the transition can run parallel to at least one side surface of the baked item. If the intention is for just one corner of the quadrilateral baked item to form a grip region, the transition can run at an angle other than 90° to the four side surfaces of the baked item. As an alternative, however, transitions which are curved or shaped in any desired manner are also possible.

The underside of the baked item need not necessarily be the underside of the subsequently produced bakery product. Rather, it is also possible for the surface which is referred to as the underside during production to also be the subsequent upper side of the finished bakery product. All of the coating substance located in the mould constitutes the subsequently set coating of the bakery product.

The underside comprises preferably just the first sub-region and the second sub-region, which is designed in the form of a grip region. The baked item may be, for example, a plain butter biscuit. Of course, other suitable baked items are also possible. A recommended coating is, for example, milk chocolate or dark chocolate. Of course, other suitable coatings are also conceivable.

The baked item may be of quadrilateral, in particular rectangular, design. If the baked item is of rectangular configuration, the coated, first sub-region may likewise be of rectangular design and can extend up to a total of three side surfaces which bound the underside. As an alternative, any other desired geometrical or figurative shapes of the baked item and of the coating are also possible.

The baked item may have, for example, a length of approximately 6 cm, a width of approximately 5 cm and a height of approximately 0.5 cm, wherein the coating may be approximately 0.3 cm. It is recommended if the grip region has a depth and/or width of approximately 1 to 2 cm, so that the bakery product can be gripped to good effect by two fingers without the fingers coming into contact with the coating.

The baked item may be provided with a coating even in at least one of those regions of the side surface(s) which are adjacent to the first sub-region, which is to be coated. If the baked item is of rectangular configuration and in the case of a transition between the uncoated, second sub-region and the coated, first sub-region being oriented parallel to two side surfaces of the baked item, the coating thus extends over a total of three opposite side surfaces. It is the case here that the middle one of the three side surfaces would be coated over its entire length and the other two, mutually opposite side surfaces would be coated only over part of their respective length. As seen in plan view of the bakery product, the coating would partially enclose the baked item in the manner of a “U”. On the two opposite side surfaces, it is possible for the height of the coating to decrease as the distance from the middle side surface increases.

The coating may terminate approximately flush with the respectively corresponding edge between at least one side surface and the upper side of the baked item. If the baked item is of rectangular design and the transition between the uncoated, second sub-region and the coated, first sub-region is oriented parallel to two side surfaces of the baked item, one side surface is coated in its entirety, whereas the height of the coating on the two adjacent, mutually opposite side surfaces decreases as the distance from the fully coated side surface increases.

The thickness of the coating can increase from the free end of the first sub-region to the grip region at least along a sub-region of the longitudinal extent of the first sub-region. The thickness of the coating can decrease from the free end of the first sub-region to the grip region at least along a sub-region of the longitudinal extent of the first sub-region.

As an alternative, the thickness of the coating may be constant at least along a sub-region of the longitudinal extent of the first sub-region.

The coating may have a positive or a negative relief or the like. It is thus possible to realize any desired configuration for the surface of the set coating. It is also possible in this way for example for names or logos to be introduced into the coating and to be represented in the set coating of the finished bakery product.

Exemplary embodiments of the invention which are illustrated in the drawings will be explained hereinbelow. In the drawings:

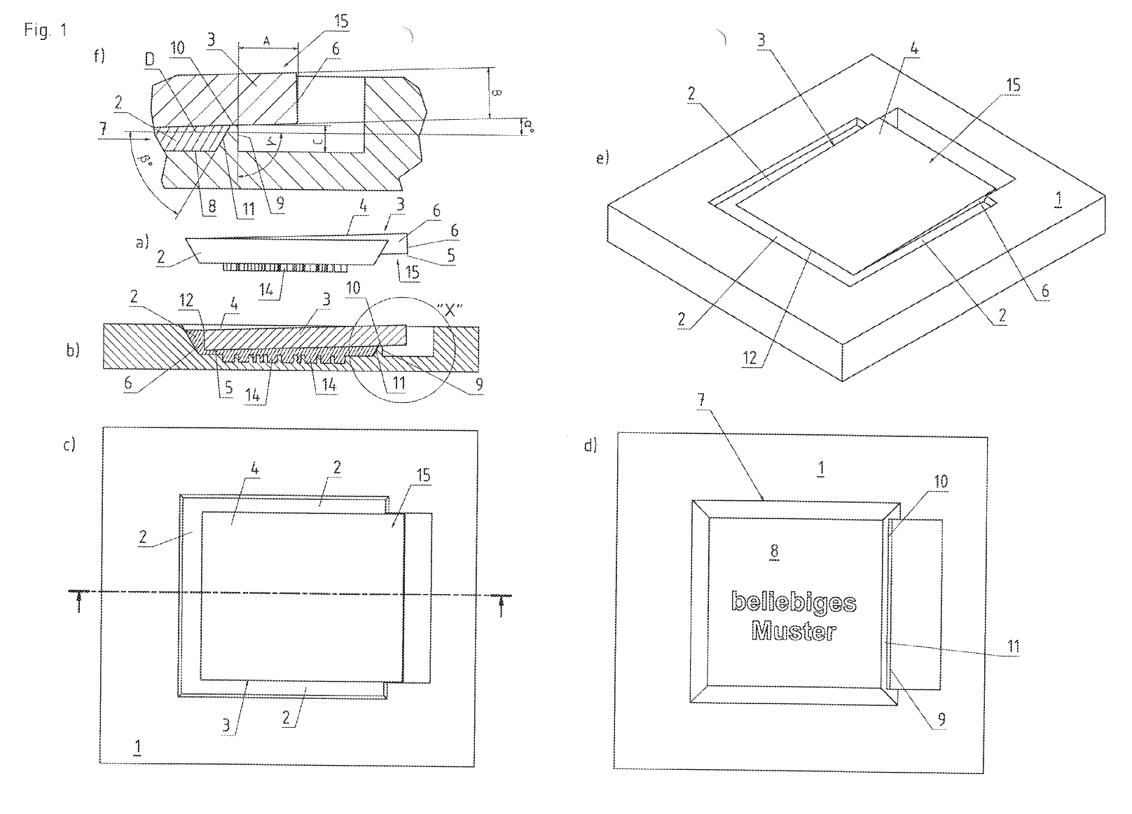

FIGS. 1a-f show a first exemplary embodiment of a mould for implementing the method according to the invention, and also a bakery product according to the invention produced thereby,

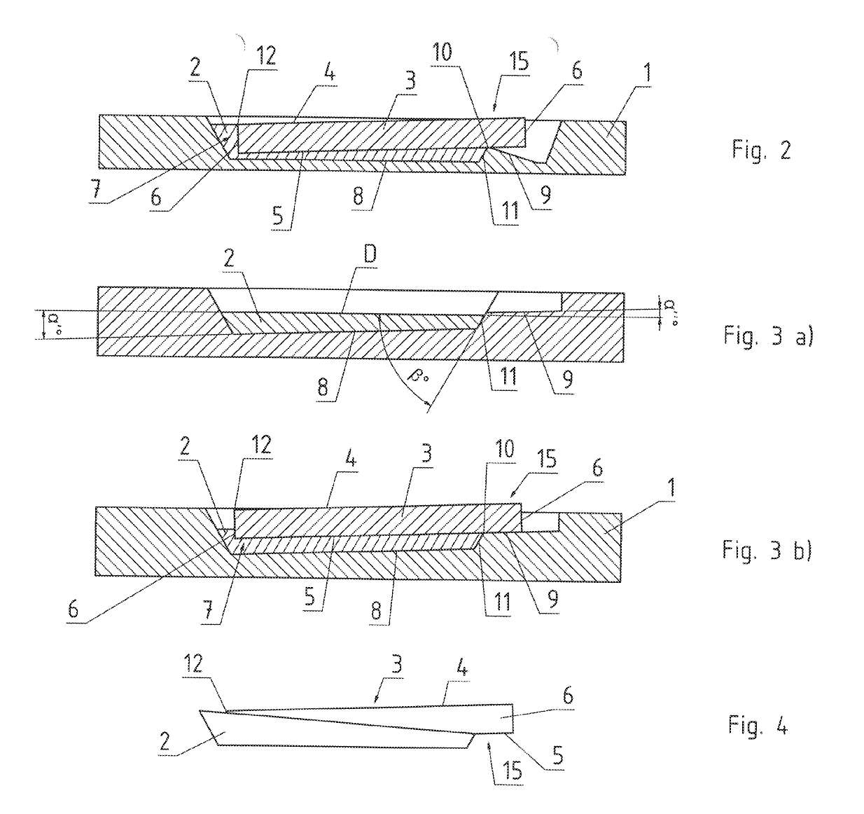

FIG. 2 shows a section through a further exemplary embodiment of a mould for implementing the method according to the invention and a bakery product according to the invention produced thereby,

FIG. 3a shows a section through a further exemplary embodiment of a mould which is filled with coating substance and is intended to implement the method according to the invention,

FIG. 3b shows a section through the exemplary embodiment according to FIG. 3a with a bakery product according to the invention produced thereby,

FIG. 4 shows a side view of the bakery product according to FIG. 2, and

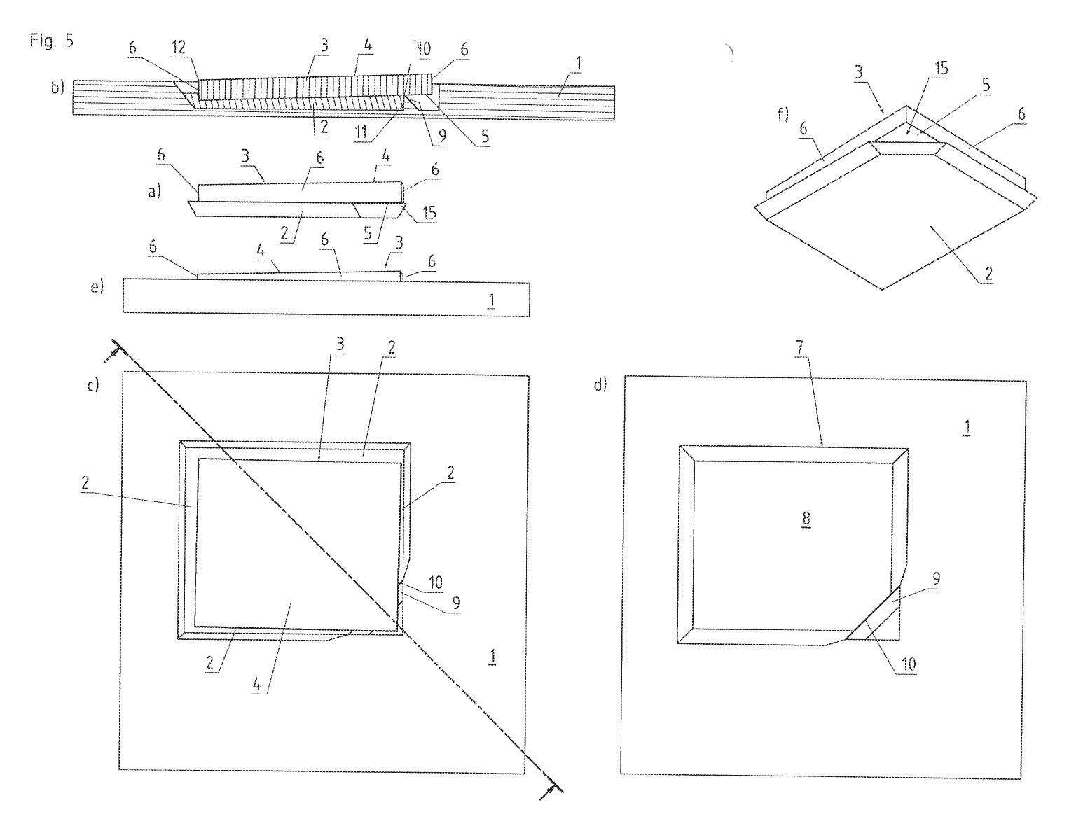

FIGS. 5a-f show a further exemplary embodiment of a mould for implementing the method according to the invention, and also a bakery product according to the invention produced thereby.

Throughout the figures, the same or similar elements are indicated by corresponding designations.

FIGS. 1a and 5a are each side views of a bakery product according to the invention. FIGS. 1b and 5b illustrate sections through the articles illustrated in FIGS. 1c and 5c, respectively.

FIGS. 1c and 1d and also 5c and 5d illustrate the respective mould 1, wherein FIGS. 1c and 5c illustrate the respective mould 1 with a coating substance 2 located therein and with a baked item 3, whereas FIGS. 1d and 5d show just the respective mould 1 itself.

FIG. 1e shows an oblique plan view of the article according to FIG. 1c, whereas FIG. 1f shows the detail “X” from FIG. 1b. FIG. 5e illustrates a side view of FIG. 5c, whereas FIG. 5f is an oblique plan view of the bakery product.

The baked item 3 which is to be coated has an upper side 4, an underside 5 and—if the baked item 3 is of quadrilateral design, as shown in the exemplary embodiments—four side surfaces 6.

As can be gathered from the figures, the moulds 1 illustrated therein have a dipping-in region 7 with a base 8. The coating substance 2 is introduced into the dipping-in region 7 in a not yet set state and, once set, forms the coating. The mould 1 also has a bearing region 9, which, for example, in the case of the exemplary embodiment according to FIG. 1b, is designed in the form of a crosspiece.

The baked item 3 rests on the bearing region 9. By virtue of the bearing region 9, the second sub-region of the baked item 3, which is not to be coated, is shielded, in particular with sealing action, from the coating substance 2. In FIG. 1, the dipping-in region 7 is wider than the bearing region 9. Following on from the bearing region 9, the mould 1 is of relatively narrow design and is coordinated with the width of the baked item 3, and therefore the second sub-region of the baked item 3, which is not be coated, is shielded laterally, in particular with sealing action, from the coating substance 2.

The bearing region 9 is designed in the form of an at least approximately vertically upwardly extending crosspiece which runs over the entire width of the mould 1. The wall region 11 of the bearing region 9, said wall region being directed towards the coating substance 2, and the edge 10 of the bearing region 9, said edge being directed towards the coating substance 2, are of rectilinear design in the exemplary embodiments illustrated, and therefore the subsequent progression of the transition, on the underside 5 of the baked item 3, between the uncoated region and the coated region is likewise of rectilinear design, as can be gathered, for example, in FIG. 1d.

It is also possible, however, for the progression of the bearing region 9 in the region of the edge 10, which is directed towards the coating substance 2, to be of, for example, undulating design, and this therefore results in a correspondingly different progression of the transition, on the underside 5 of the baked item 3, between the uncoated region and the coated region.

In FIGS. 3a and 3b, the bearing region 9 is designed in the form of a planar bearing surface which extends beyond the free end of the baked item 3. The bearing region 9 is oriented at an angle α″ of approximately 2° in relation to the original surface of the coating substance 2, i.e. prior to the baked item 3 being placed in position.

For example in FIG. 2, the base 8 of the dipping-in region 7 is oriented horizontally, whereas FIG. 3 shows an exemplary embodiment in which the base 8 is oriented at an angle α′ of 2° to the original surface of the coating substance 2, i.e. prior to the baked item 3 being dipped in. It is also possible for the angle α′ to be different and thus to influence the layer thickness of the coating substance and the geometry thereof.

In the case of the exemplary embodiment according to FIG. 1, the base 8 of the dipping-in region 7 has a relief 14 in the form of two words. The bearing region 9, on its side directed towards the coating substance 2, is oriented at an angle β of approximately 62° to the original surface “D” of the bath, this original surface being illustrated in the form of a dotted line in FIG. 1f. The bearing region, on its side directed away from the coating substance 2, is oriented at an angle γ of approximately 90° to the original surface “D” of the bath. As an alternative, the angle may be in the range 0<γ−(180°−β).

In the exemplary embodiment illustrated in FIG. 2, the base 8 of the mould 1 is oriented parallel to the original surface of the bath.

For coating purposes, the baked item 3 is placed in position from above on the not yet set coating substance 2. When the first sub-region of the underside 5 of the baked item 3, which is to be coated, comes into contact with the surface of the coating substance 2, this sub-region of the baked item 3 sinks readily into the coating substance 2 on account of its weight. It is also possible for a specific pushing-in action to take place. This means that the level of the coating substance 2 rises in the mould 1 on account of the coating substance 2 being displaced by the baked item 3 sinking in, and therefore the first sub-region, which is to be coated, is coated.

Once the baked item 3 has been placed in position, the mould, which has been filled to this extent, may be subjected to vibration. Part of the baked item 3 here sinks into the coating substance 2.

Following completion of the operation of the baked item sinking in, the mould 1 can be cooled. This results in the coating substance 2 setting, and a coating forms. The bakery product can now be removed from the mould 1. For this purpose, it is possible for the mould 1 to be, for example, turned and—if the mould 1 is sufficiently flexible—twisted, in order to facilitate removal.

The uncoated, second sub-region of the underside 5 is shielded from the coating substance 2 by the bearing region 9 during the coating operation. This means that the underside 5 is only coated in the first sub-region. The uncoated, second sub-region of the underside 5, together with the upper side 4, forms a grip region 15 following the coating operation.

Since the dipping-in region 7—as is illustrated in the figures—is wider than the baked item 3, the coating substance 2, in the case of the exemplary embodiments according to FIGS. 1 to 4, is located in the region of three side surfaces 6.

In the case of the exemplary embodiment illustrated in FIG. 5, the uncoated, second sub-region, and therefore also the grip region 15 formed thereby, are of triangular design.

In the case of the embodiments according to FIGS. 1 and 2, the height of the coating substance 2 in the mould 1 is such that the coating substance 2, in that region of the baked item 3 which dips into the lowest level, terminates approximately flush with the edge 12 between the side surface 6 and the upper side 4 of the baked item 3. The three side surfaces 6 adjacent to the first sub-region of the underside 5, which is to be coated, are likewise at least partially coated, and therefore, as seen in plan view, the coating encloses the bakery product in the manner of a “U”.

In the case of the exemplary embodiment illustrated in FIG. 2, the thickness of the coating increases from the free end of the first sub-region to the grip region 15. It is also, of course, possible, however, for the thickness of the coating to be constant over the first sub-region, as is illustrated in FIG. 3b.

As can be gathered, for example, from FIG. 1b, the side surface 6 which has been dipped in to the lowest level is fully coated. On the one hand, the coating, on the two adjacent, mutually opposite side surfaces 6, as illustrated in FIG. 1a, does not extend over the entire length of the respective side surface 6. On the other hand, the height of the coating decreases as the distance from the fully coated “middle” side surface 6 increases.

If the base 8 of the dipping-in region 7 has a relief 14, it is possible for any desired pattern or any desired name—as is indicated in FIG. 1d—to be introduced into the coating, although the surfaces of the baked item 3 themselves are essentially planar.

The baked item 3 illustrated in FIG. 1 may have a length of approximately 6 cm, a width of approximately 5 cm and a height “B” of approximately 0.5 cm, wherein the coating which is to be applied is approximately 0.3 cm. It is recommended, in the case of these dimensions, if the distance “A”, which defines the width of the subsequent grip region 15, is approximately 1 to 2 cm and the angle α between the underside 5 of the baked item 3 and the original surface of the coating substance 2 is approximately 2° and the angle β between the original surface of the coating substance 2 and that side of the bearing region 9 which is directed towards the coating substance 2 is approximately 62°. The height “C” of the bearing region 9 is set preferably at approximately 0.3 cm.

1. A method of producing a bakery product which comprises a baked item (3) having at least one underside (5), which is formed by at least one, preferably at least essentially planar, surface, having an upper side (4), which is formed by at least one, preferably at least essentially planar, surface, and having at least one side surface (6), which connects the upper side (4) and the underside (5) to one another, wherein a sub-region of the underside (5) of the baked item (3) is provided with a coating, wherein a first sub-region of the underside (5), which extends over the entire width, but only over part of the longitudinal extent, is coated and a second sub-region of the underside (5), which extends in particular over the entire width, but only over part of the longitudinal extent, remains uncoated in the form of a grip region (15), wherein, for coating purposes, use is made of a mould (1), in which a bath of not yet set coating substance (2) is provided, wherein the baked item (3) has that sub-region of the partial-coat underside (5) which is to be coated dipped into the not yet set coating substance (2) and then the coating substance (2) is set, in particular by cooling, and thus forms the coating, wherein the underside of the baked item (3), which is to be coated, is oriented at an angle α between 1° and 20° in relation to the original surface of the bath of the not yet set coating substance at least during the operation of setting the not yet set coating substance (2).

2. A method according to 1, wherein the angle α is between 1° and 5°, preferably is 2°.

3. A method according to claim 1, wherein the baked item (3) is of quadrilateral, in particular rectangular, design.

4. A method according to claim 1, wherein the thickness of the coating increases from the free end of the first sub-region to the grip region (15) at least along a sub-region of the longitudinal extent of the first sub-region, and/or in that the thickness of the coating decreases from the free end of the first sub-region to the grip region (15) at least along a sub-region of the longitudinal extent of the first sub-region.

5. A method according to claim 1, wherein the thickness of the coating is constant at least along a sub-region of the longitudinal extent of the first sub-region.

6. A method according to claim 1, wherein the height of the coating substance (2) in the mould is such that the baked item (3), by virtue of being dipped into the not yet set coating substance (2), is provided with a coating even in at least one of those regions of at least one of the side surfaces (6) which are adjacent to the first sub-region, which is to be coated.

7. A method according to claim 1, wherein the baked item (3) is dipped into the not yet set coating substance (2) to such an extent that, with the baked item (3) dipped in, the coating substance (2), in that region of the baked item (3) which dips into the lowest level, terminates approximately flush with the corresponding edge (12) between the side surface (6) and the upper side (4) of the baked item (3).

8. A method according to claim 1, wherein the baked item (3) is dipped into the not yet set coating substance (2) to such an extent that the coating also partially covers over the upper side (4) of the baked item (3).

9. A method according to claim 1, wherein the mould (1) has a dipping-in region (7) which accommodates the not yet set coating substance (2) and has a base (8) and a bearing region (9), wherein the baked item (3) rests on the bearing region (9) and, by virtue of the bearing region (9), the second sub-region of the baked item (3), which is not to be coated, is shielded, in particular with sealing action, from the coating substance (2).

10. A method according to claim 9, wherein the bearing region (9) is designed in the form of an at least approximately vertically upwardly extending crosspiece which runs over the entire width of the mould (1).

11. A method according to claim 9, wherein the bearing region (9) is designed in the form of a planar bearing surface which extends in particular beyond the free end of the baked item (3).

12. A method according to claim 9, wherein the surface of the bearing region (9) is oriented at an angle α″, which is between 1° and 20°, preferably 2°, to the original surface of the coating substance (2).

13. A method according to claim 9, wherein the base (8) of the dipping-in region (7) is oriented at an angle α′, which is between 0° and 20°, preferably 2°, to the surface of the coating substance (2).

14. A method according to claim 9, wherein the base (8) of the dipping-in region (7) has a relief (14) or the like.

15. A method according to claim 1, wherein it is either the case that, in the region located laterally in relation to the second sub-region of the baked item (3), which is not to be coated, the mould (1) has side walls with at least an approximately vertical orientation corresponding to the shape of the baked item (3), wherein, in the dipped-in position of the baked item (3), the second sub-region of the side surface(s) of the baked item (3), which is not to be coated, is shielded, in particular with sealing action, from the coating substance by the side walls, or else the mould has at least two spaced-apart fixing elements, which fix the baked item laterally during the dipping-in operation.

16. A method according to claim 9, wherein the bearing region (9), on the side directed towards the coating substance (2), is oriented at an angle β, which is between 50° and 90°, preferably is 62°, to the original surface of the bath.

17. A bakery product comprising a baked item (3) having an underside (5), which is formed by at least one, preferably at least essentially planar, surface, having an upper side (4), which is formed by at least one, preferably at least essentially planar, surface, and having at least one side surface (6), which connects the upper side (4) and the underside (5) to one another, wherein a first sub-region of the underside (5) of the baked item (3) is provided with a coating which extends over the entire width, but only over part of the longitudinal extent, and a second sub-region of the underside (5), which extends in particular over the entire width, but only over part of the longitudinal extent, is uncoated in the form of a grip region (15), wherein the upper side (4) of the baked item (3) is likewise uncoated at least in the grip region (15).

18. A bakery product according to claim 17, wherein the baked item (3) is provided with a coating even in at least one of those regions of the side surface(s) (6) which are adjacent to the first sub-region, which is to be coated.

19. A bakery product according to claim 17, wherein the coating terminates approximately flush with the corresponding edge (12) between the side surface (6) and the upper side (4) of the baked item (3).

20. A bakery product according to claim 17, wherein the thickness of the coating increases from the free end of the first sub-region to the grip region (15) at least along a sub-region of the longitudinal extent of the first sub-region, and/or in that the thickness of the coating decreases from the free end of the first sub-region to the grip region (15) at least along a sub-region of the longitudinal extent of the first sub-region.

21. A bakery product according to claim 17, wherein the thickness of the coating is constant at least along a sub-region of the longitudinal extent of the first sub-region.

22. A bakery product according to claim 17, wherein the coating has a relief (14) or the like.
